(19) United States
(12) Patent Application Publication
(10) Pub. No.: US 2004/0121478 A1
(43) Pub. Date: Jun. 24, 2004

(54) Optical sensor

(76) Inventors: Thomas Brinz, Bissingen Unter Der Teck (DE); Mary Lewis, Gerlingen (DE)

Correspondence Address: KENYON & KENYON, ONE BROADWAY, NEW YORK, NY, 10004, US

(21) Appl. No.: 10/612,449

(22) Filed: Jul. 1, 2003

(30) Foreign Application Priority Data
Jul. 3, 2002 (DE) 102 29 756.8

(51) Int. Cl. G01N 21/64

(52) U.S. Cl. 436/109; 436/167; 436/118; 436/122; 436/133

(57) ABSTRACT

An optical gas sensor for determining a gas, in particular in air, having a radiation source, a detector and a sensitive layer in the beam path of the radiation source. The sensitive layer contains at least one oligomer or polymer having at least one side chain, the side chain having at least one basic or acidic functional group.

### FIELD OF THE INVENTION

The present invention relates to an optical sensor.

### BACKGROUND INFORMATION

Optical sensors for determining the concentration of a gas, e.g., the carbon dioxide content in air, are used in fire alarms, among other things. Their function is based on a sensor layer that is sensitive to carbon dioxide and changes color reversibly on coming in contact with the gas to be determined. A detector detects this color change, an alarm being triggered when a defined minimum concentration is exceeded.

Such sensors are required to detect very low gas concentrations with sufficient accuracy. With an increase in absorption capacity of the sensitive layer of a sensor for the gas to be determined, the change in the sensor signal becomes more rapid. Also, optical absorption in the sensitive layer is greater due to the higher gas concentration to be determined in the sensitive layer, thus permitting more precise sensor measurement results.

International Patent Application No. WO 00/02844 describes an oligomeric quaternary alkylammonium cation provided in the sensitive layer of a carbon dioxide sensor, quaternary ammonium functions being included in the main chain of the polymer. The quaternary ammonium cation is a hydroxide which gives a basic reaction. This increases uptake of carbon dioxide by the sensitive layer. However, problems are to be expected with the long-term stability of the sensitive layer, because the oligomeric alkylammonium cation, due to its polarity, may result in polymer matrix separation.

### SUMMARY

An object of the present invention is to provide an optical sensor for determination of a gas to permit accurate measurement results promptly and to have a stable sensitive layer and the greatest possible gas permeability.

An example optical sensor according to the present invention may allow highly precise measurement of extremely low gas concentrations. This is accomplished in that the sensitive layer of the sensor contains an oligomer or polymer having side chains, a basic or acidic functional group being present in at least one of the side chains. An advantage of this type of oligomer or polymer is that the number of pH-active centers in the molecule may be varied as needed, and thus the basicity or acidity of the sensitive layer is adjustable. At the same time, the type of main chain of the oligomer or polymer is relatively freely selectable, so that separation of the sensitive layer is effectively prevented by a suitable choice of the main chain. The free selectability of the main chain of the oligomer or polymer also makes it possible to design the polymer matrix of the sensitive layer to be porous and gas permeable through a choice of suitable oligomers or polymers. A porous sensitive layer permits a greater layer thickness of the sensitive layer and thus permits detection of the gas to be determined even in the trace range on the basis of the resulting greater optical absorption. Therefore, in general a more accurate measurement signal is obtained.

It may be advantageous to use oligomers or polymers in which the side chains have more than one pH-active functional group. This increases the basicity or acidity of the particular oligomer or polymer. It is advantageous in particular to use quaternary ammonium or phosphonium hydroxides as basic functional groups and/or to use sulfonic, phosphonic or carboxylic acids as acidic functional groups, because these are readily accessible preparatively.

It may also be advantageous if the polymer matrix of the sensitive layer contains polydimethylsiloxane as the base material because it has very good diffusion properties for carbon dioxide in particular.

### BRIEF DESCRIPTION OF THE DRAWINGS

Two exemplary embodiments of the present invention are illustrated in the drawings and explained in greater detail in the following description.

FIG. 1 shows schematically a sensor design according to a first exemplary embodiment of the optical sensor according to the present invention.

FIG. 2 shows a sensor design according to a second exemplary embodiment.

### DESCRIPTION OF EXAMPLE EMBODIMENTS

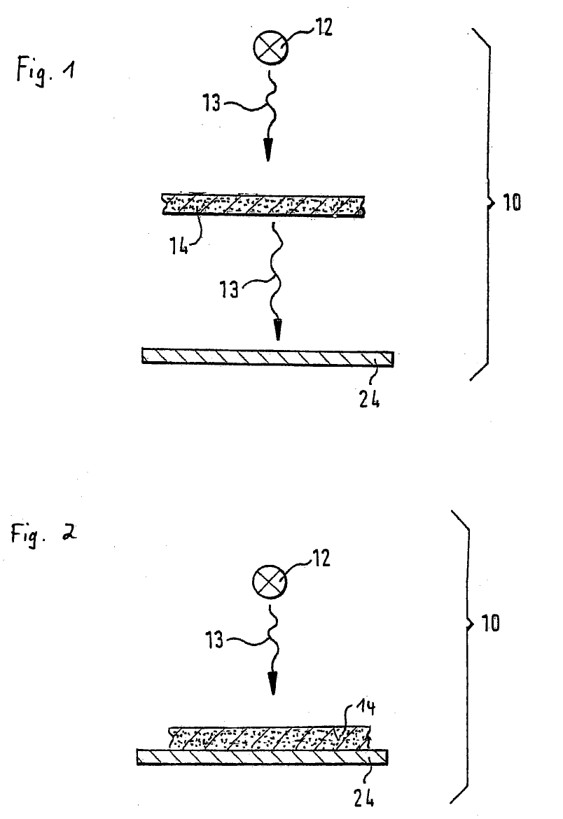

Optical sensor 10 shown in FIG. 1 has a radiation source 12, e.g., an LED, and a detector 24, which is designed as a photodiode, for example. A sensitive layer 14 provided between radiation source 12 and detector 24 is applied, e.g., to a transparent substrate of glass (not shown). Other optically transparent materials such as polymethacrylates may also be used for the transparent substrate.

Sensitive layer 14 undergoes a reversible color change when a minimum concentration of the gas to be determined is exceeded. Sensitive layer 14 has a polymer matrix containing the compounds, e.g., a pH indicator, responsible for the sensitivity of the sensor. In a preferred embodiment of sensitive layer 14, the polymer matrix is based on polydimethylsiloxane. However, other silicones or polymers such as PVC or ethylcellulose are also suitable.

When polydimethylsiloxane is the base polymer of the polymer matrix, sensitive layer 14 has a very good response to carbon dioxide, because the CO₂ diffusion rate is very high due to the good gas permeability of the polymer. Although it is otherwise customary to add plasticizers, they may be omitted here.

In this embodiment, the layer thickness of sensitive layer 14 should not exceed 20 μm, because adequate diffusion of the gas to be determined into sensitive layer 14 is no longer ensured otherwise. In addition, sensitive layer 14 is preferably porous to ensure access of the gas mixture into virtually all areas of the layer. An open-pore design of sensitive layer 14 is preferred in particular, i.e., the gas spaces enclosed in the pores are in mutual communication to ensure virtually unhindered access of the gas atmosphere to sensitive layer 14.

The function of sensitive layer 14 is based on the presence of a pH-active substance in addition to a pH indicator such as brilliant yellow. In the embodiment of sensor 10 for detection of acidic gases, which, when dissolved in an aqueous medium, cause a decline in pH of the solution, sensitive layer 14 of the sensor contains a base as the pH-active substance. When sensor 10 is used for detection of basic gases, which raise the pH of the solution when dissolved in an aqueous medium, sensitive layer 14 will contain an acid as the pH-active substance.

In the first case, the base contained in sensitive layer 14 creates a basic medium in the layer and converts the pH indicator to its deprotonated form having a first color. As soon as an acidic gas such as carbon dioxide comes in contact with sensitive layer 14, it reacts with water present in the layer to form hydrogen carbonate HCO₃⁻ and hydronium ions H₃O⁺. This reaction changes the pH of the layer and results in reprotonation of the pH indicator, causing the pH indicator and sensitive layer 14 to show a color change. This color change is detected by measuring the absorption or transmittance in particular wavelength ranges of radiation 13.

A polymer in which the main chain has at least one side chain is added as the pH-active substance to sensitive layer 14, at least one of the side chains having at least one pH-active functional group, pH-active being understood to refer to a functional group that will react protolytically with water. In the sense of this patent application, polymer is understood to include oligomers.

The main chain of the polymer may generally be selected freely. Polyethylenes, polydiallyls, polyacrylates or polymethacrylates, polyisocyanates, polyamides or polysiloxanes are suitable. The miscibility of the pH-active polymer with the base polymer of sensitive layer 14 and the porosity of the layer are adjustable through a suitable choice of the main chain.

If basic functional groups are present in a side chain of the pH-active polymer, they may have, e.g., the basic structures (I), (II) and (III) shown below. Basic structure (I) is a polymer having side chains including a quaternary ammonium function; basic structure (II) is a polymer having side chains bridging two vicinal carbons of the polymer main chain and one quaternary ammonium function; and basic structure (III) is a polymer having side chains containing multiple quaternary ammonium functions.

In these formulas, the Rₓ groups denote molecular fragments, preferably based on hydrocarbons, where the Rₓ groups may have functional groups or heteroatoms. The variously labeled Rₓ groups may denote the same or different molecular fragments. The R₁ groups plus R₂ and R₁₀ in basic structure (II) may also denote a carbon-nitrogen bond.

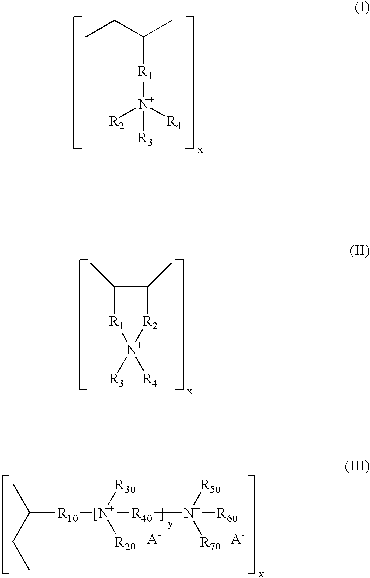

Anions A⁻ in these basic structures may have a valency of 1 or 2 and are preferably basic. Suitable examples include hydroxide, phosphate or carbonate ions.

As an alternative, quaternary phosphonium functions may also be provided instead of quaternary ammonium functions in basic structures (I) through (III).

Examples of compounds corresponding to one of the basic structures (I) through (III) mentioned above which are suitable in particular include:

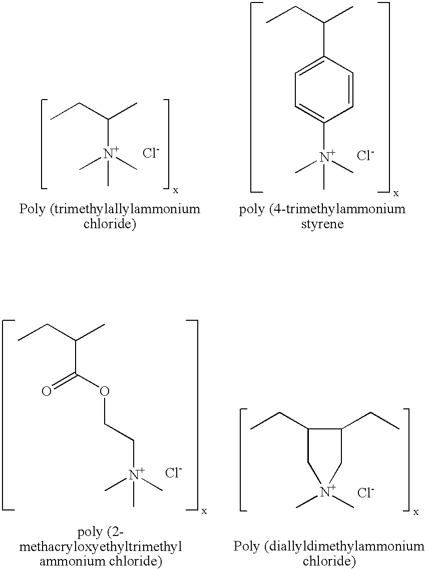

Sensors that are preferably used to determine basic gases such as ammonia, phosphines or low alkylamines preferably contain in sensitive layer 14 a polymer whose side chains contain only acidic functional groups or both acidic and basic functional groups. A combination of acidic and basic functional groups in the side chains of the polymer increases the reversibility of the reaction of the side chain polymer with the gas to be determined.

The side chains of the polymer have sulfonic, phosphonic or carboxylic acid groups in particular as acidic functional groups. The following basic structures (IV), (V) and (VI) are possible:

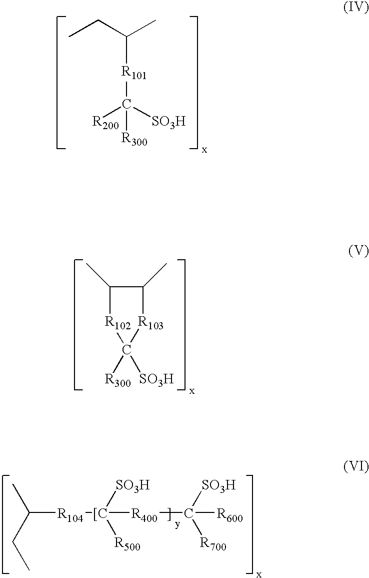

The Rₓ groups may be hydrogen or molecular fragments comparable to those provided in the basic structures (I) through (III). The R₁₀₁ through R₁₀₄ groups may also be carbon-carbon bonds or heteroatom-carbon bonds. The R₃₀₀, R₅₀₀ and R₇₀₀ groups may additionally denote a C—C double bond to one of the other Rₓ groups of the side chain.

As an alternative, phosphonic or carboxylic acid functions may also be provided instead of the sulfonic acid groups in basic structures (IV) through (VI).

Compounds which are suitable in particular include:

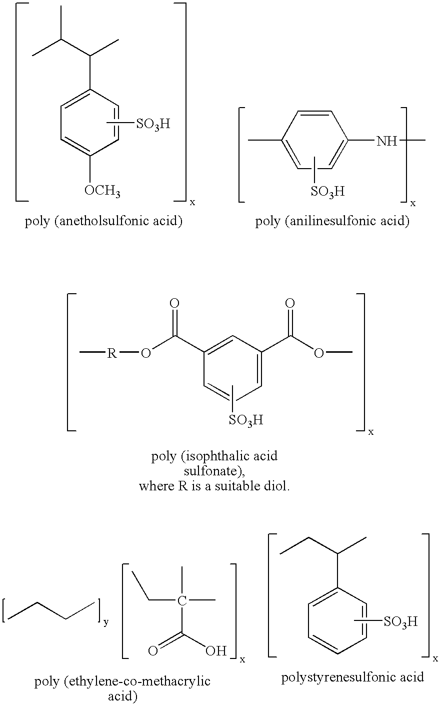

Within one polymer, the side chains of the pH-active polymers indicated in basic structures (I) through (VI) may have identical or different structures. Alternating or irregular sequences of side chains having different structures and/or different numbers of pH-active functional groups may be provided within a polymer.

According to a second embodiment of the sensor shown in FIG. 2, sensitive layer 14 is not applied to a substrate but instead is applied directly to detector 24, thus simplifying the design of the optical sensor.

The present invention is not limited to the exemplary embodiments described here, but instead other embodiments are also possible in addition to the optical sensors illustrated in the figures and described here, depending on the application. For example, it is possible to determine a wide variety of acidic or basic gases, e.g., CO₂, NOₓ, SO₂, SO₃, NH₃ or hydrogen halide compounds. With a suitable design of sensitive layer 14, it is also possible to determine CO or HCN.

What is claimed is:

1. An optical gas sensor for determining a gas component in air, comprising a radiation source;
a detector; and
a sensitive layer in a beam path of the radiation source, the sensitive layer containing at least one oligomer or polymer having at least one side chain, the side chain having at least one basic or acidic functional group.

2. The optical sensor as recited in claim 1, wherein the sensitive layer is positioned between the radiation source and the detector.

3. The optical gas sensor as recited in claim 1, wherein the side chain contains at least one of a quaternary ammonium function and a phosphonium function, as the basic functional group.

4. The optical gas sensor as recited in claim 1, wherein the side chain contains at least one of a carboxylic function, phosphonic function, and a sulfonic acid function as the acidic functional group.

5. The optical gas sensor as recited in claim 1, wherein the side chain has the general formula [—R₁—NR₂R₃R₄]⁺A⁻, where —R₁— is one of a bridging molecular fragment or a carbon-nitrogen bond, by which the side chain is attached to the main chain of the oligomer or polymer, R₂, R₃ and R₄ denoting other groups that are functionalized or functionalizable, and A⁻ is an anion.

6. The optical gas sensor as recited in claim 1, wherein the side chain has the general formula [(—R₁—) (—R₂—)NR₃R₄]⁺A⁻, where —R₁— and —R₂— are bridging molecular fragments or carbon-nitrogen bonds by which the side chain is attached to the main chain of the oligomer or polymer, R₃ and R₄ denoting other groups that are functionalized or functionalizable, and A⁻ is an anion.

7. The optical gas sensor as recited in claim 4, wherein the bridging molecular fragment R₁ has the general formula [—R₁₀—[NR₂₀R₃₀—R₄₀—]ₓ-]^{(x)+}(x)/n Aⁿ⁻, where —R₁₀— is a bridging molecular fragment or a carbon-nitrogen bond by which the side chain is attached to the main chain of the oligomer or polymer, R₂₀, R₃₀ and R₄₀ denoting groups that are functionalized or functionalizable, —R₄₀— being a bridging group, Aⁿ⁻ being an anion and x being an integer greater than 0.

8. The optical gas sensor as recited in claim 1, wherein the side chain has the general formula —R₁₀₄—[—CR₄₀₀SO₃H—R₅₀₀—]ₓ[—CR₆₀₀R₇₀₀SO₃H], where —R₁₀₄— is a bridging molecular fragment or a carbon-carbon bond by which the side chain is attached to the main chain of the oligomer or polymer, R_{400,} R₅₀₀, R₆₀₀ and R₇₀₀ denoting other groups that are functionalized or functionalizable, or a C—C double bond to one of the other Rₓ groups, R₄₀₀ being a bridging group, A⁻ being an anion and x being an integer greater than or equal to 0.

9. The optical gas sensor as recited in claim 1, wherein the side chain has at least one acidic functional group and at least one basic functional group.

10. The optical gas sensor as recited in claim 1, wherein the sensitive layer contains polydimethylsiloxane.

11. The optical gas sensor as recited in claim 1, wherein the sensitive layer has a layer thickness of 20 μm to 100 μm.

12. The optical gas sensor as recited in claim 1, wherein the sensitive layer is on a substrate which is the detector.

13. A method of detecting at least one of CO₂, NOₓ, SO₂, SO₃, NH₃, CO, HCN, and hydrogen halide compounds, comprising:
providing a sensitive layer between a radiation source and a detector, the sensitive layer containing at least one oligomer or polymer having at least one side chain, the side chain having at least one basic or acidic functional group; and
detecting at least one of CO₂, NOₓ, SO₂, SO₃, NH₃, CO, HCN, and a hydrogen halide compound using the sensitive layer and the detector.
